(19) United States
(12) Patent Application Publication
(10) Pub. No.: US 2019/0136554 A1
(43) Pub. Date: May 9, 2019

(54) Insulated Therapy Tub

(71) Applicant: Hobson Anthony Howell, Woodway, TX (US)

(72) Inventor: Hobson Anthony Howell, Woodway, TX (US)

(21) Appl. No.: 15/806,211

(22) Filed: Nov. 7, 2017

(51) Int. Cl. E04H 4/00; A47K 3/00; A47K 3/022; A61H 33/00

(52) U.S. Cl. CPC E04H 4/0018; A61H 33/6005; A47K 3/022; A47K 3/003

(57) ABSTRACT

An insulated therapy tub for provision of cold-water therapy to athletes or physical therapy patients in a warm environment that includes a tub body that is filled with an insulating layer and which is capable of easy transport and storage when not in use.

### TECHNICAL FIELD OF THE INVENTION

The present invention is generally directed to tubs, including physical therapy tubs and athletic training tubs, that are used by athletic trainers to provide post-workout cold-water immersion therapy to athletes and by physical therapists to provide cold-water immersion therapy to physical therapy patients.

### BACKGROUND ART OF THE INVENTION

Intense physical workouts, strenuous exercise and participation in endurance sports typically result in athletes experiencing significant muscle soreness, swelling, and joint pain due to the breakdown of bodily tissues brought about by prolonged physical exertion. Many athletic trainers and experienced athletes use cold water baths or ice baths (sometimes referred to as “cold-water immersion therapy”) in order to alleviate post-workout or postgame muscle soreness and joint pain. It is widely accepted that cold water baths or ice baths that are taken following an intense workout or athletic competition are effective in relieving swelling and inflammation of muscles and other bodily tissues that result from tissue breakdown and cellular stress or damage. Cold-water immersion therapy is commonly used by top-tier football players, marathoners, swimmers, cyclists, and many other high-level athletes. Athletic trainers at all levels, including professional, collegiate, and high school, use cold-water immersion therapy for treating athletes who have muscle soreness, swelling, and significant post-workout and postgame physical pain. Cold-water immersion therapy may also sometimes be used by physical therapists providing therapy to their physical therapy patients and for patients who have undergone strenuous physical therapy sessions.

At the present time, cold-water immersion therapy is commonly provided to many athletes by athletic trainers and to patients by physical therapists using a variety of metal and plastic containers, such as metal horse feeders, cattle troughs, large plastic tubs, or even backyard plastic pools for children (commonly referred to as “kiddie pools”). Some of these simple devices only accommodate one athlete or patient at a time, while others are large enough and have enough volumetric capacity to contain multiple persons who are concurrently undergoing cold-water immersion therapy. In the context of athletic trainers providing cold-water immersion therapy to athletes, the most commonly encountered device used for this purpose is an uninsulated, black plastic tub. The metal or plastic containers commonly used for cold-water therapy are typically filled with ice, an ice-water slurry, or chilled water, and one or more athletes or patients sits in the tub in order to receive the cold-water immersion therapy. The troughs, tubs or other containers that are employed may be made of aluminum, steel, or another rigid metal, but as set forth above, black plastic tubs are probably the most commonly used device by athletic trainers for provision of cold-water immersion therapy. Once one or a few initial athletes have undergone cold-water immersion therapy in a trough, tub or other similar container, the trough, tub, or other container may be drained or emptied before another athlete, or small group of athletes, use the same trough, tub, or similar container for additional cold-water immersion therapy sessions, but it is more common for multiple athletes or groups of athletes to undergo cold-water immersion therapy in consecutive sessions using the same trough, tub, or other container before it is drained.

Providing cold-water immersion therapy by using either metal containers, such as horse feeders and cattle troughs, or thin-walled, uninsulated plastic containers, such as black plastic tubs or kiddie pools, is not ideal. While cold-water immersion therapy is sometimes provided in the office of an athletic trainer, in a locker room, or in a physical therapist's clinic, it is also very often provided outside in warm or even hot environments where the ambient temperatures can reach 80° F. to 120° F. In such warm environments, the cold water or ice water slurry in the trough, tub, or other container that is being used can warm rapidly due to conduction heating through the metal or plastic walls of the trough, tub, or other container, and also to some extent due to convection heating by the ambient air flowing across the top surface of the cold water or ice water slurry that is contained within the well of the tub or other container.

Additional issues are encountered with the current provision of cold-water immersion therapy to athletes or physical therapy patients using simple metal and plastic containers such as feeders, troughs, or tubs. The devices that are most frequently used fir cold-water immersion therapy do not contain means for recirculating cooled or chilled water. The devices are often heavy, bulky, and difficult to transport due to the material from which the devices are constructed or simply due to the shape and configuration of the devices. The floors of the devices that are frequently used are smooth and do not provide traction for athletes or patients trying to enter or exit the device before or after the provision of cold-water immersion therapy. Further, the walls of the devices that are most frequently employed are generally straight, vertical sides that are not comfortable for athletes or patients who are sitting inside the well of the tub or other container taking a cold-water bath or ice bath. It is an object of the disclosed device to remedy many of these most commonly-encountered problems.

### SUMMARY OF THE INVENTION

An insulated therapy tub for provision of cold-water immersion therapy to athletes or physical therapy patients is disclosed. Problems and limitations in the prior art are overcome by the disclosed insulated therapy tub that is readily portable when drained, and when in use for provision of cold-water therapy, permits provision of such therapy to multiple athletes or patients simultaneously using one tub because the tub well has a large volumetric capacity. The tub features a composite circular shell that is comprised of a low thermoconductive, insulating foam layer encased between sturdy polymeric inside and outside walls, wherein the insulating foam layer contained between the inside and outside walls serves to significantly impede heat conduction through the tub's composite circular shell and preserves extremely cold temperatures within the well of the tub while athletes or patients undergo cold-water immersion therapy. It is understood that the well of the tub will typically be used by trainers or physical therapists to contain an ice-water slurry for the cold-water immersion therapy, and the nature of the tub shell with its insulating foam layer between the inside and outside walls is such that the ice-water slurry will remain an ice-water mixture for a much longer time than a conventional metal trough or uninsulated plastic tub.

Additionally, the tub disclosed herein has a number of practical safety and transport/storage features that make it superior to prior art tubs that have been used for cold-water immersion therapy. The insulated therapy tub has a plurality of raised ribs that are located along the bottom inside surface of the tub's well that facilitate ingress and egress from the well of the tub by athletes or patients who are about to undergo cold-water immersion therapy in the tub, or athletes or patients who are done with therapy and need to exit the tub. The inside wall of the tub is sloped from the upper rim of the tub's circular shell down to the bottom planar surface defining the bottom of the tub's well. This slope makes it easier and more comfortable for athletes or patients undergoing cold-water immersion therapy to sit relax in a recumbent position during therapy. Furthermore, the tub itself when viewed as a whole is a right circular cylinder, which is a shape that facilitates rolling the tub along the floor or ground when it needs to be transported from one location to another location or when the tub must be put away for storage. Moreover, the upper rim of the tub's circular vertical wall has at least two hand grips that also facilitate moving and transporting the tub. The tub further comprises at least one drain outlet that may be used to either fill or drain the tub with water or other liquid. Other features of the tub will be apparent from the following detailed description taken with reference to the accompanying drawings.

### BRIEF DESCRIPTION OF THE DRAWINGS

The disclosed insulated therapy tub will be described with reference to the accompanying, drawings, which show important sample embodiments, wherein:

FIG. 1 is a top view of the insulated therapy tub where the outside vertical wall of the tub that is located behind the top surface of the tub is indicated by a dashed line and certain section lines for later cross-sectional views are indicated;

FIG. 2 is front view of the insulated therapy tub where the sloped inside vertical wall of the tub, the bottom inside surface of the tub's well, and the raised ribs on the bottom surface, all of which are behind the front surface of the tub, are indicated with dashed lines;

FIG. 3 is a bottom view of the insulated therapy tub where the top and bottom circumferences of the sloped inside vertical wall and a plurality of raised ribs that are located along the bottom inside surface of the tub's well, all of which are above the bottom surface of the tub, are indicated by dashed lines;

FIG. 4 is a side view of the insulated therapy tub where the sloped inside vertical wall, the inside bottom surface of the tub well, and a plurality of raised ribs that are located along the inside bottom surface of the tub's well, all of which are behind the side surface of the tub, are indicated by dashed lines;

FIG. 5 is a sectional view taken at 5-5 of FIG. 1;

FIG. 6 is a sectional view taken at 6-6 of FIG. 1;

FIG. 7 is a sectional view taken at 7-7 of FIG. 1;

FIG. 8 is a top view of an alternative embodiment of the insulated therapy tub.

### DETAILED DESCRIPTION OF THE PREFERRED EMBODIMENTS

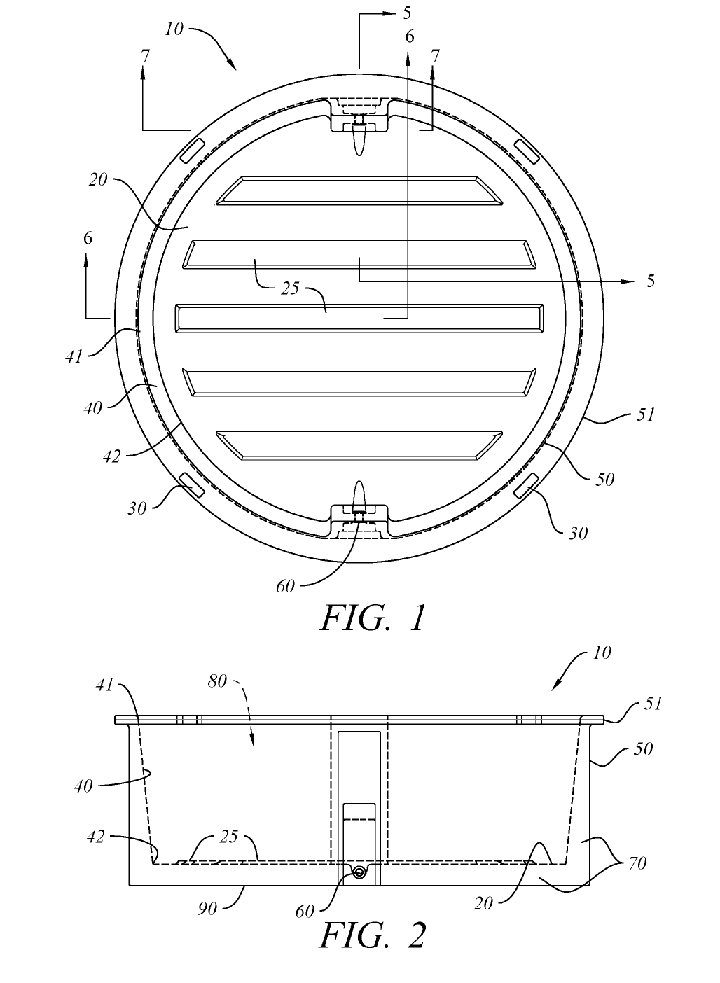

FIG. 1 illustrates an insulated therapy tub 10 configured to contain cold water, ice, an ice-water slurry, or other liquids or liquid-solid combinations, primarily for the purpose of providing cold-water immersion therapy to athletes or physical therapy patients. The tub 10 is a right circular cylinder with an outside vertical wall 50 and a circular upper rim 51 in which at least two, and preferably four, hand grips 30 are disposed, wherein the hand grips 30 are rectangular or oval shaped holes through the upper rim 51 that allow for the tub 10 to be lifted for transport or storage. The tub 10 also includes an inside vertical wall 40 that slopes upwardly from its bottom circular edge 42 that adjoins the inside bottom surface 20 to its top circular edge 41 that adjoins the upper rim 51 of the tub 10. In a preferred embodiment., the slope of the inside vertical wall 40 from bottom circular edge 42 to top circular edge 41 is 19° past vertical. The incline or slope of the inside vertical wall 40 is intended to increase the comfort of potential occupants of the tub 10. The tub 10 has an inside bottom surface 20 that features a plurality of raised ribs 25 that are intended to facilitate ingress and egress from the tub by potential occupants. The tub 10 also contains at least one, and preferably two, drain openings 60 that may be selectively plugged or connected to any standard type of valve that may be used to keep water or other fluid in the tub 10 or to drain the tub 10 through the drain openings 60 following use.

FIG. 2 again shows the insulated therapy tub 10 and illustrates many of the same features as FIG. 1. As shown, the inside vertical wall 40 slopes upwardly from where it meets the inside bottom surface 20 at the bottom circular edge 42 to where the top circular edge 41 meets the upper rim 51 of the tub 10. The at least one drain opening 60, outside vertical wall 50, and the raised ribs 25 of the inside bottom surface 20 are likewise again illustrated. As shown in FIG. 2, the inside vertical wall 40, and the inside bottom surface 20 with its raised ribs 25, cooperate to form the bathing well 80. As further illustrated by FIG. 2, the tub 10 has an outside bottom surface 90 that is a flat circular surface. FIG. 2 also generally illustrates the fact that there is a. space interval 70 between the outside vertical wall 50 and the inside vertical wall 40, and that the space interval 70 continues between the outside bottom surface 90 and the inside bottom surface 20. During manufacture, the space interval 70 will be filled with an insulating material (not illustrated in 2) that will provide resistance to thermal conduction between the outside vertical wall 50 and the inside vertical wall 40, as well as resistance to thermal conduction between the outside bottom surface 90 and the inside bottom surface 20. Thus, the space interval 70 will normally be filled with an insulating material that will be allowed to cure prior to completion of manufacture of the tub 10. In a preferred embodiment, the outside bottom surface 90, the outside vertical wall 50, the upper rim 51, the inside vertical wall 40, and the inside bottom surface 20 with its raised ribs 25, are all formed from a single, rigid, unitary polymer material such that the individual features described are all part of a single tub body containing the space interval 70 into which insulating material will be introduced during manufacture of the tub 10.

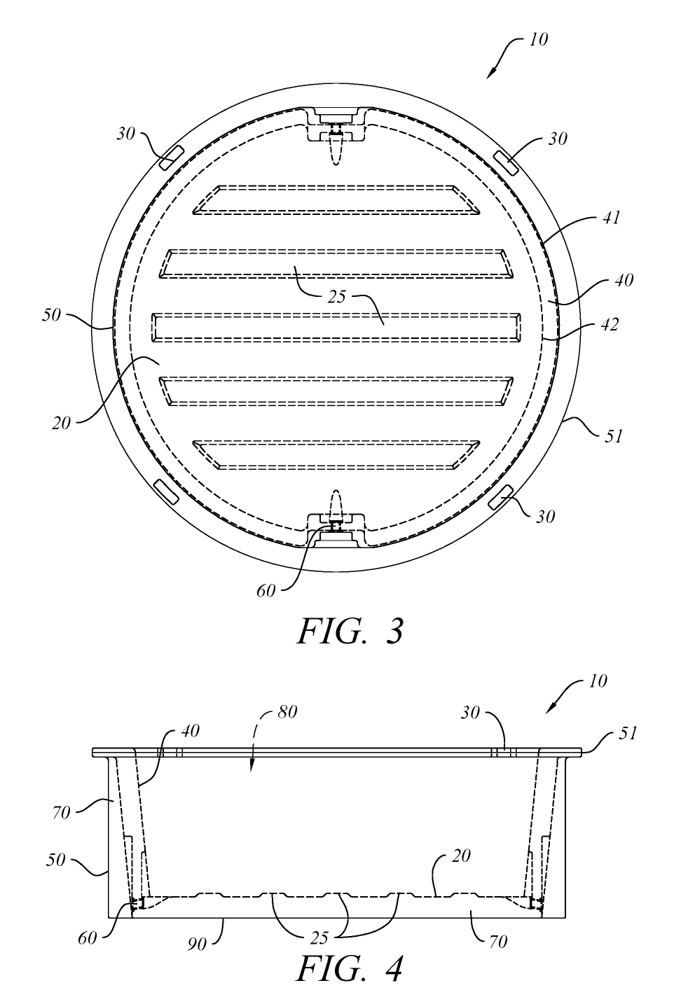

FIG. 3 generally illustrates many of the same features of the tub 10 already discussed, but from a different viewpoint.

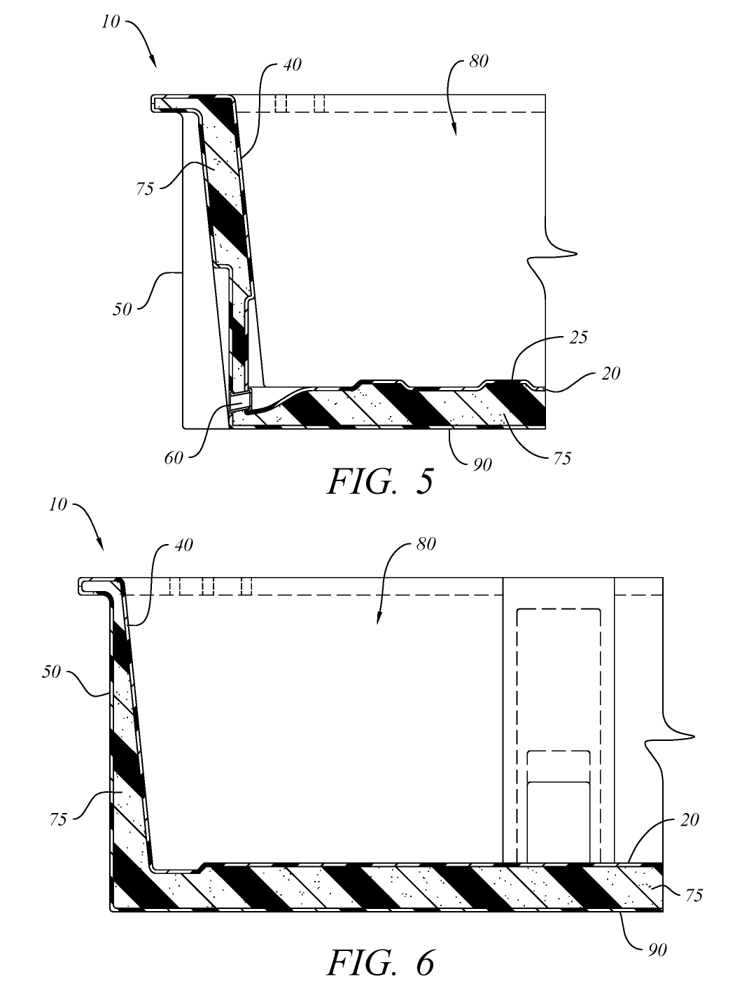

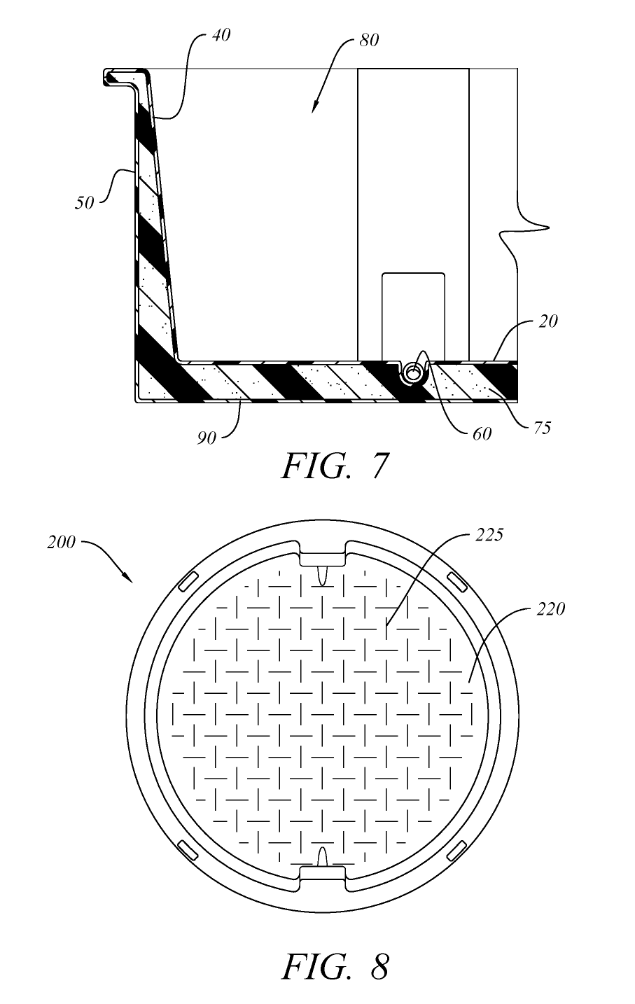

As illustrated in FIG. 4, there is a space interval 70 that is a void between the inside vertical wall 40 and the outside vertical wall 50. The space interval 70 also exists as a void between the outside bottom surface 90 and the inside bottom surface 20. The space interval 70 will be filled with an insulating material (not shown) during manufacture of the tub 10 so that cold water, ice-water slurries, and other cold liquids or liquid-solid mixtures placed into the tub 10 will be insulated from heat that is external to the tub 10 and so that conduction of heat energy from the outside vertical wall 50 and from the outside bottom surface 90 are greatly impeded. Thus, the space interval 70 will sometimes subsequently be illustrated as containing an insulating material that is the insulating foam layer (shown in FIGS. 5-7 in the completed tub),

Making now reference to FIGS. 5-7, the outside bottom surface 90, the outside vertical wall 50, the upper rim 51, the inside vertical wall 40, and the inside bottom surface 20 with its raised ribs 25, are all rigid materials wherein at least the inside vertical wall 40, and the inside bottom surface 20 with its raised ribs 25, are made of material that is waterproof. As stated previously, in a preferred embodiment, the outside bottom surface 90, the outside vertical wall 50, the upper rim 51, the inside vertical wall 40, and the inside bottom surface 20 with its raised ribs 25, are all formed from a single, rigid, unitary polymer material such that the individual features described are all part of a single tub body. The polymer material used may be a molded fiberglass, Poly(methyl methacrylate)/acrylic, polypropylene, polyethylene, melamine plastic, a synthetic resinous material, or other desirable polymer. In a preferred embodiment, the polymer material is a low density polyethylene homopolymer.

As shown in FIGS. 5-7, during manufacture of the tub 10, an insulating material 75 is injected or blown into the former space interval (shown in FIGS. 2, 4). In the completed tub 10, insulating material 75 forms a layer between the outside bottom surface 90 and the inside bottom surface 20, and between the inside vertical wall 40 and the outside vertical wall 50. The insulating layer 75 may be a rigid urethane or polyurethane foam, a foaming polystyrene, or fabrication thereof, or an inorganic powder such as perlite. These candidates for the insulating material 75 may be introduced into the space interval as pellets or sprayed-in foam during the manufacture process, typically through a small hole in either the inside vertical wall 40 or the outside vertical wall 50 that allows access to the space interval for filling with the insulating material. In a preferred embodiment, the insulating material 75 is comprised of a tetrafluoroethane/polymethylene polyphenyl isocyanate composition that exists as a foam inside the space interval of the tub 10.

FIG. 8 shows an alternative embodiment of the tub 200 in which the inside bottom surface 220 has a cross-hatched raised ribs 225 that offer traction for athletes and patients who are attempting to enter or exit the tub at the beginning or end of cold-water immersion therapy treatments.

The preferred embodiment of the tub is comprised of a single, unitary tub body that is 100% rotationally molded plastic. In the preferred embodiment, the tub body is produced by rotational molding in which a male and female mold are brought into close proximity to form a cavity between the two molds with the circumferential edges of the molds are joined near the area where the upper rim of the tub will be formed. The male and female molds are heated and. rotated while a polymer dust is inserted into the cavity between the two molds, and the polymer dust begins to form a unitary tub body as the polymer dust is deposited on the surface of each mold and begins to thermoset into a rigid, unitary tub body having the shape and the features described above. During the rotational molding process, a portion of the initial cavity between the male and female molds is preserved internally as the space interval 70, and a small hole in the tub body that allows access to the space interval 70 for filling with the insulating material 75 is also formed. The male and female molds may also be designed such that at least one, and preferably two, drain openings between the inside vertical wall and the outside vertical wall passing through the space interval are formed during the rotational molding process. The molds may further be designed to include formation of at least two, and preferably four, hand grips in the upper rim of the tub.

Once the polymer is cured on both molds during the rotational molding process, there is a unitary tub body formed that is comprised of the outside bottom surface 90 and the outside vertical wall 50 (collectively the outer surface of the tub body), the upper rim 51, and the inside vertical wall 40 and inside bottom surface 20 with its raised ribs 25 (collectively the inside surface of the tub body). At least one, and preferably two, drain openings passing through the outer surface of the tub body and the inner surface of the tub body and through the space interval, as well as at least two, and preferably four hand grips in the upper rim, may also exist in preferred embodiments of the tub (or these features could possibly be added later by cutting or drilling such holes in a completed tub body, though this is not preferred). The whole tub body is then removed from the molds. At this stage in the manufacturing process, the incomplete tub is at least comprised of the tub body that has been described, the space interval 70, and the small hole in the tub body for filling the space interval 70 with insulating material 75, and may optionally include the drain openings and hand grips mentioned above. The space interval 70 is normally now filled with the insulating material 75 in the form of pellets or blown-in foam, and then the insulating material 75 goes through a curing process that may include a thermosetting process to cure a resinous or wet foam polymer that has been inserted or blown into the space interval 70 in order to form the completed insulating material 75. At the end of the curing process, the completed tub is ready for use.

As stated previously, the polymer material used to form the tub body in a preferred embodiment is a low density polyethylene homopolymer, and the insulating material in a preferred embodiment is a tetrafluoroethane/polymethylene polyphenyl isocyanate composition that will cure into a hard foam. If hand grips and a drainage hole were not already incorporated as integral features of the tub during the rotational molding process described, they may be cut or drilled into the body of the tub at the end of the manufacturing process. However, in a preferred manufacturing process, these features are provided for by the shape of the male and female molds that are used during the rotational molding process.

Thus, the completed insulated therapy tub after manufacture can be described as a right circular cylinder comprising: 1) a tub body comprised of an outside vertical wall, inside vertical wall, upper rim, outside bottom surface, and inside bottom surface; 2) an insulating material that forms an insulating layer located between the outside surface of the tub body and the inside surface of the tub body, and a bathing well that is designed to contain chilled water, ice-water slurries, ice, or other cold liquids or cold liquid-solid mixtures that are suitable for cold-water immersion therapy. In a preferred embodiment, the dimensions of the insulated therapy tub will be such that the bathing well of the insulated therapy tub will have a volumetric capacity of at least 400 gallons if completely filled with liquid water, and when completely drained of all liquid the tub will weigh no more than 130 pounds. In a preferred embodiment, the polymeric material used for molding the tub body will not be black or dark in coloration because it has been found that using black polymer material for the tub body increases the absorption of heat and therefore results in warming of the contents that may be placed in the bathing well of the tub, which is counterproductive to the goal of keeping the contents within the well as cool as possible for as long as possible during the provision of cold-water immersion therapy.

The insulated therapy tub disclosed in this application may potentially be connected to a pump and refrigeration system that pumps chilled water into and out of the tub. To the extent that some embodiments of the tub contain two drain openings, one of the drain openings may potentially be used as an inlet for chilled water to be pumped into the tub from a refrigeration or chiller unit using a pump, with the second drain opening being used to drain warmer water out of the tub. While not strictly necessary to use the insulated therapy tub for cold-water immersion therapy, such an arrangement may be advantageous over repeated filling of ice into the tub as a method of continuing to cool any liquid or liquid-solid mixture that may be contained within the bathing well of the tub.

Although the inventive concepts hereby disclosed have been described with reference to specific embodiments, it should be understood that the above-described specific embodiments are not intended to limit the scope of the inventive concepts disclosed, but merely to illustrate some of the specific embodiments of the insulated therapy tub. It should be understood that various modifications of the disclosed embodiments, as well as alternative embodiments of the inventive concepts, will be apparent to persons skilled in the art upon reference to the description of the embodiments that is provided or upon reference to the appended claims. It is, therefore, contemplated that the appended claims will cover and read upon all such modifications and alternative embodiments that fall within the scope of the inventive concepts that are claimed by the inventor.

I claim:

1. A tub comprising:
a tub body that is rigid and is comprised of an outside bottom surface, an outside vertical wall, an inside vertical wall, and an inside bottom surface;
a bathing well;
wherein there is a void provided within the tub body that is filled with insulating material.

2. A tub as in claim 1 wherein the insulating material is comprised of a foam formed from a tetrafluoroethane/polymethylene polyphenyl isocyanate composition that has been allowed to cure.

3. A tub as in claim 1 wherein the tub body is a rigid, unitary structure comprised of a low density polyethylene homopolymer.

4. A tub as in claim 1 wherein the insulating material is comprised of a foam formed from a tetrafluoroethane/polymethylene polyphenyl isocyanate composition that has been allowed to cure and the tub body is a rigid, unitary structure comprised of a low density polyethylene homopolymer.

5. A tub as in claim 1 wherein the inside bottom surface further comprises a plurality of raised ribs.

6. A tub as in claim 5 wherein the tub body is in the shape of a right circular cylinder.

7. A tub as in claim 6 further comprising a tub rim where the inside vertical wall is connected to the outside vertical wall.

8. A tub as in claim 7 wherein the inside vertical wall is connected to the inside bottom surface and the inside vertical wall is sloped outwardly in relation to the tub's center from where the inside vertical wall is connected to the inside bottom surface to where the inside vertical wall is connected to the tub rim.

9. A tub as in claim 8 further comprising at least two distinct hand grips that are disposed within the tub rim.

10. A tub as in claim 9 further comprising at least one drain opening that may be used to drain liquid from the bathing well through the tub body and outside of the tub.

11. A tub as in claim 10 wherein the total dry weight of the tub is no more than 130 pounds.

12. A tub as in claim 11 wherein the bathing well has a volumetric capacity of at least 400 gallons.

13. A tub as in claim 12 wherein the insulating material is comprised of a foam formed from a tetrafluoroethane/polymethylene polyphenyl isocyanate composition that has been allowed to cure and the tub body is a rigid, unitary structure comprised of a low density polyethylene homopolymer.

14. A tub comprising:
an outside surface;
an inside surface;
an insulating layer disposed between the outside surface and the inside surface;
a bathing well defined by the inside surface;
wherein the tub is in the shape of a right circular cylinder.

15. A tub as in claim 14 wherein the insulating layer is comprised of a foam formed from a polymethylene polyphenyl isocyanate composition and the outside surface and the inside surface are each comprised of a low density polyethylene homopolymer.

16. A tub as in claim 15 wherein the inside surface has a flat plane at its base that is provided with a plurality of raised ribs.

17. A tub as in claim 16 that further comprises at least one hand grip for manually grasping the tub.

18. A tub as in claim 17 that further comprises a drain opening that is a hole through the inside surface, the insulating layer, and the outside surface which may be used to fill or drain the tub.

19. A method of manufacturing a tub comprising:
placing a male tub mold within close proximity to a female mold such that there is a cavity between the two molds but the outermost circumferential edges of the molds abut against each other;
heating and rotating the male and female molds at the same speed;
inserting polymer dust into the cavity between the two molds and allowing the polymer dust to adhere to the surfaces of each mold such that the polymer dust becomes thermoset into a rigid, unitary tub body within the molds;
limiting the amount of polymer dust inserted into the cavity between the molds to the extent necessary that the initial cavity between the molds is partially preserved as a void within the rigid, unitary tub body;
Removing the rigid, unitary tub body from the molds;
Injecting or inserting insulating material into the void within the rigid, unitary tub body;
Allowing the insulating material to expand and cure so that it forms an insulating layer within the now-filled void of the rigid, unitary tub body.

20. The method of claim 19 wherein the insulating layer is comprised of a polymethylene polyphenyl isocyanate composition and the rigid, unitary tub body is comprised of a low density polyethylene homopolymer.
